(19) United States
(12) Patent Application Publication
(10) Pub. No.: US 2014/0272869 A1
(43) Pub. Date: Sep. 18, 2014

(54) PLATFORMS, SYSTEMS, SOFTWARE, AND METHODS FOR ONLINE CPR TRAINING AND CERTIFICATION

(71) Applicant: Health & Safety Institute, Eugene, OR (US)

(72) Inventors: John William HAMBELTON, Eugene, OR (US); William ROWE, Eugene, OR (US); Ralph M. SHENEFELT, Dunedin, FL (US); William H. CLENDENEN, Eugene, OR (US); Adam KEISLING, Eugene, OR (US); Frank POWERS, JR., Eugene, OR (US)

(73) Assignee: Health & Safety Institute, Eugene, OR (US)

(21) Appl. No.: 14/207,275

(22) Filed: Mar. 12, 2014

Related U.S. Application Data
(60) Provisional application No. 61/788,700, filed on Mar. 15, 2013.

(51) Int. Cl. G09B 23/28

(52) U.S. Cl. CPC G09B 23/288
USPC 434/265

(57) ABSTRACT

Disclosed are web-based CPR training and certification platforms comprising: 1) a controller device comprising: a first mode for collecting student compression data; a second mode for collecting student breath data; and a software module for transmitting the data to a server application; and 2) a server processor configured to provide an application comprising: a training mode, a practice mode, and a certification mode; a software module for providing a student interface; and a software module for providing an instructor interface. Optionally, feedback on student CPR psychomotor skills is provided in the form of a single-player or multi-player game played by performing the skills.

### CROSS-REFERENCE TO RELATED APPLICATIONS

This application claims the benefit of U.S. Application Ser. No. 61/788,700, filed Mar. 15, 2013, which is hereby incorporated by reference in its entirety.

### BACKGROUND OF THE INVENTION

CPR training and certification has great value to society. When properly applied to those in need, CPR restores partial flow of oxygenated blood to the brain and heart. As a result, CPR has the potential to delay tissue death and to extend the brief window of opportunity for successful resuscitation without permanent brain damage.

### SUMMARY OF THE INVENTION

Guidelines for CPR education published by the American Heart Association®, Inc., European Resuscitation Council, and International Liaison Committee on Resuscitation emphasize the importance of high-quality CPR; chest compressions of adequate rate and depth, complete chest recoil, minimal interruptions and the avoidance excessive ventilation. Substantial hands-on practice is necessary to meet these psychomotor skill performance objectives.

Certification requires verification that a CPR course participant has demonstrated achievement of the required hands-on skill performance objectives. Acquisition of hands-on skills is verified via a skill test conducted in person by a qualified, on-site instructor or through a self-directed course using a voice assisted manikin In contrast, the platforms, systems, devices, applications, and methods described herein create a system that that includes a self-paced online instructional program to verify cognitive knowledge, computer software and a device that collects skill data points including feedback on compression and breathing, and permits skill testing, verification and certification by a qualified, remote, off-site instructor via live or recorded video conference.

Advantages of the platforms, systems, devices, applications, and methods described herein include, but are not limited to, enabling CPR skill training, practice, and testing, including the issuance of certification remotely to a single participant and/or groups of participants by an instructor or instructors at a distant location with the same or better quality as an instructor being physically present in the classroom. Further advantages include offering a high-quality, systematic approach to certification that rivals in-person CPR certification in addition to video capture analysis, and tracking of the participant's knowledge and skill performance in an integrated system.

In one aspect, disclosed herein are web-based CPR training and certification platforms comprising: 1) a controller device comprising: a first mode for collecting student compression data; a second mode for collecting student breath data; a software module for providing feedback on the compression and breath data; and a software module for transmitting the data to a server application; and 2) a server processor configured to provide an application comprising: a training mode, a practice mode, and a certification mode; a software module for providing a student interface, the student interface configured to deliver learning content in the training mode and display instructor feedback in the practice mode; and a software module for providing an instructor interface, the instructor interface configured to provide video of student psychomotor skills in the practice and certification modes, provide a graphical display of student compression and breath data in the practice and certification modes, allow provision of feedback in the practice and certification modes, and allow issuance of a CPR certification in the certification mode. In some embodiments, the controller device automatically switches between the first mode and the second mode. In some embodiments, the student compression data comprises compression rate and compression depth. In some embodiments, the student breath data comprises chest rise. In some embodiments, the controller device comprises an accelerometer. In some embodiments, the controller device comprises a gyroscope. In some embodiments, the controller device comprises a CPR manikin. In some embodiments, the controller device is in communication with a computer. In further embodiments, the transmission of data to a server processor is performed via the computer. In further embodiments, the computer comprises a digital video camera. In some embodiments, the cognitive content comprises an online CPR course. In further embodiments, the cognitive content comprises one or more of: instructional video, photographs, text, audio, and combinations thereof. In further embodiments, the cognitive content comprises a test or quiz. In some embodiments, the feedback provided by the device comprises lights, sounds, or a combination thereof. In some embodiments, the video of student psychomotor skills is substantially real-time video. In some embodiments, the video of student psychomotor skills is archived video. In some embodiments, the feedback provided by the instructor comprises text, images, audio, video, or a combination thereof. In some embodiments, the graphical display of student compression and breath data comprises a compression:breath ratio. In some embodiments, the platform further comprises a database for storing historic student data, instructor data, and certification data. In some embodiments, the application further comprises a software module for scheduling practice and certification, the scheduling comprising matching instructor and student availability. In some embodiments, the application further comprises a software module for conducting e-commerce transactions. In further embodiments, the e-commerce transactions are for purchasing the related online cognitive content for CPR training or digital certification cards issued following successful completion of the course.

In another aspect, disclosed herein are CPR training and certification devices comprising: an accelerometer, a gyroscope, or both; a first mode for collecting student compression data by the accelerometer; a second mode for collecting student breath data by the accelerometer, wherein the device automatically switches between the first mode and the second mode; a software module for providing feedback on the compression and breath data; and a software module for transmitting the data to a server application for evaluation by a CPR instructor. In some embodiments, the student compression data comprises compression rate and compression depth. In some embodiments, the student breath data comprises chest rise. In some embodiments, the controller device further comprises a gyroscope. In some embodiments, the device is integrated with a CPR manikin. In some embodiments, the device is in communication with a computer. In further embodiments, the communication is performed by Wi-Fi, Zigbee, Bluetooth, or a combination thereof. In further embodiments, the transmission of data to a server processor is performed via the computer. In further embodiments, the computer comprises a digital video camera. In some embodiments, the feedback provided by the device comprises lights, sounds, or a combination thereof. In some embodiments, the feedback is provided during training and suppressed during certification. In some embodiments, the device comprises a smartphone. In some embodiments, the first mode, the second mode, and the software modules are implemented as a mobile application.

In another aspect, disclosed herein are non-transitory computer-readable storage media encoded with a computer program including instructions executable by a processor to create a CPR certification application, the application adapted for a CPR instructor, the application comprising: a software module configured to provide video of the student performing psychomotor skills; a software module configured to receive student compression and breath data; a software module configured to provide a graphical display of student compression and breath data; a software module configured to allow provision of feedback; and a software module configured to allow issuance of a CPR certification. In some embodiments, the student compression data comprises compression rate and compression depth. In some embodiments, the student breath data comprises chest rise. In some embodiments, the video of student psychomotor skills is substantially real-time video. In some embodiments, the video of student psychomotor skills is archived video. In some embodiments, the feedback provided by the instructor comprises text, images, audio, video, or a combination thereof. In some embodiments, the graphical display of student compression and breath data comprises a compression:breath ratio. In some embodiments, the application further comprises a database for storing historic student data, instructor feedback data, and certification data. In some embodiments, the application further comprises a software module for scheduling practice and certification, the scheduling comprising matching instructor and student availability.

In another aspect, disclosed herein are web-based CPR training and certification platforms comprising: a plurality of controller devices, each controller device operated by a student, each controller device comprising: an accelerometer; a first mode for collecting raw student compression data via the accelerometer; a second mode for collecting raw student breath data via the accelerometer; a means for transmitting the raw compression and breath data to a hub device; a hub device comprising: a means for receiving raw compression and breath data from each of the controller devices; a digital signal processor configured to process the raw compression and breath data and generate compression rate, compression depth, and breath chest rise data for each of the controller devices; a means for transmitting the compression rate, compression depth, and breath chest rise data to a server application; a server processor configured to provide an application comprising: a training mode, a practice mode, and a certification mode; a software module for providing a student interface, the student interface configured to deliver learning content to each student in the training mode and display instructor feedback to each student in the practice mode; a software module for providing an instructor interface, the instructor interface configured to provide video of student psychomotor skills for each student in the practice and certification modes, provide a graphical display of compression rate, compression depth, and breath chest rise data for each student in the practice and certification modes, allow provision of feedback to each student in the practice and certification modes, and allow issuance of a CPR certification to each student in the certification mode. In some embodiments, the plurality of controller devices comprises about 2 to about 8 controller devices. In some embodiments, in the practice mode, the compression and breath data for each student are generated by each student playing a game, the game requiring performance of CPR psychomotor skills and the feedback on the compression and breath data is provided by reactions of the game. In further embodiments, the game is a multi-player game.

### BRIEF DESCRIPTION OF THE DRAWINGS

FIG. 1 shows a non-limiting example of a controller device described herein; in this case, a controller device for measuring, collecting, and transmitting student compression data and student breath data.

FIG. 2 shows a first non-limiting exemplary overview of the platform described herein; in this case, an overview demonstrating student application functions and instructor application functions.

FIG. 3 shows a second non-limiting exemplary overview of the platform described herein; in this case, an overview demonstrating a web-based practice or certification session, wherein a student interface captures data pertaining to a student's performance of psychomotor skills and an instructor interface presents video and graphical data pertaining to the student's skill performance.

FIG. 4 shows a non-limiting example of a certification process flow described herein; in this case, a process flow including purchase and completion of an instructional course, real-time performance and review of psychomotor skills, and issuance of a certification.

FIG. 5 shows a non-limiting example of a CPR instructor interface for a remote CPR training and certification platform; in this case, an interface for viewing scheduled remote skills verification sessions.

FIG. 6 shows a non-limiting example of a CPR instructor interface for a remote CPR training and certification platform; in this case, an interface for scheduling remote skills verification sessions.

FIG. 7 shows a non-limiting example of a CPR instructor interface for a remote CPR training and certification platform; in this case, an interface for administering a CPR training class.

FIG. 8 shows a non-limiting example of a CPR instructor interface for a remote CPR training and certification platform; in this case, an interface for remote CPR skills verification including video of the student performing the skills and a graphical display of student compression and breath data.

FIG. 9 shows a non-limiting example of a student welcome screen for a remote CPR training and certification platform.

FIG. 10 shows a non-limiting example of a CPR student interface for a remote CPR training and certification platform; in this case, an interface for registration and log-in.

FIG. 11 shows a non-limiting example of a CPR student interface for a remote CPR training and certification platform; in this case, an interface for listing CPR training classes.

FIG. 12 shows a non-limiting example of a CPR student interface for a remote CPR training and certification platform; in this case, an interface for delivering CPR course lessons.

FIG. 13 shows a non-limiting example of a CPR student interface for a remote CPR training and certification platform; in this case, an interface for scheduling remote skills verification.

FIG. 14 shows a non-limiting example of a CPR student interface for a remote CPR training and certification platform; in this case, an interface for displaying student compression and breath data and providing feedback.

FIG. 15 shows a non-limiting example of a CPR student interface for a remote CPR training and certification platform; in this case, an interface for remote CPR skills verification.

FIG. 16 shows a non-limiting example of a CPR student interface for a remote CPR training and certification platform; in this case, an interface providing feedback on student compression and breath skills in the form of a driving game.

FIG. 17 shows a non-limiting example of a CPR student interface for a remote CPR training and certification platform; in this case, an interface providing feedback on student compression and breath skills in the form of a CPR game.

FIG. 18 shows a non-limiting example of a CPR student interface for a remote CPR training and certification platform; in this case, an interface including high score board to encourage competition and performance in students.

FIG. 19 shows a non-limiting exemplary schematic for a hub device for a remote CPR training and certification platform; in this case, a hub device connecting four controller devices to a host computer and a mobile device.

FIG. 20 shows a non-limiting exemplary schematic for a hub device for a remote CPR training and certification platform; in this case, a hub device with a flattened oval form factor and six USB ports for connection to controller devices.

FIG. 21 shows a non-limiting exemplary schematic overview of the multi-player platform described herein; in this case, a platform utilizing a hub device to connect a plurality of controller devices to a multi-player environment with a multi-player display.

### DETAILED DESCRIPTION OF THE INVENTION

Described herein, in certain embodiments, are web-based CPR training and certification platforms comprising: 1) a controller device comprising: a first mode for collecting student compression data; a second mode for collecting student breath data; a software module for providing feedback on the compression and breath data; and a software module for transmitting the data to a server application; and 2) a server processor configured to provide an application comprising: a training mode, a practice mode, and a certification mode; a software module for providing a student interface, the student interface configured to deliver learning content in the training mode and display instructor feedback in the practice mode; and a software module for providing an instructor interface, the instructor interface configured to provide video of student psychomotor skills in the practice and certification modes, provide a graphical display of student compression and breath data in the practice and certification modes, allow provision of feedback in the practice and certification modes, and allow issuance of a CPR certification in the certification mode.

Also described herein, in certain embodiments, are CPR training and certification devices comprising: an accelerometer, a gyroscope, or both; a first mode for collecting student compression data by the accelerometer; a second mode for collecting student breath data by the accelerometer, wherein the device automatically switches between the first mode and the second mode; a software module for providing feedback on the compression and breath data; and a software module for transmitting the data to a server application for evaluation by a CPR instructor.

Also described herein, in certain embodiments, are non-transitory computer-readable storage media encoded with a computer program including instructions executable by a processor to create a CPR certification application, the application adapted for a CPR instructor, the application comprising: a software module configured to provide video of the student performing psychomotor skills; a software module configured to receive student compression and breath data; a software module configured to provide a graphical display of student compression and breath data; a software module configured to allow provision of feedback; and a software module configured to allow issuance of a CPR certification.

Also described herein, in certain embodiments, are web-based CPR training and certification platforms comprising: a plurality of controller devices, each controller device operated by a student, each controller device comprising: an accelerometer; a first mode for collecting raw student compression data via the accelerometer; a second mode for collecting raw student breath data via the accelerometer; a means for transmitting the raw compression and breath data to a hub device; a hub device comprising: a means for receiving raw compression and breath data from each of the controller devices; a digital signal processor configured to process the raw compression and breath data and generate compression rate, compression depth, and breath chest rise data for each of the controller devices; a means for transmitting the compression rate, compression depth, and breath chest rise data to a server application; a server processor configured to provide an application comprising: a training mode, a practice mode, and a certification mode; a software module for providing a student interface, the student interface configured to deliver learning content to each student in the training mode and display instructor feedback to each student in the practice mode; a software module for providing an instructor interface, the instructor interface configured to provide video of student psychomotor skills for each student in the practice and certification modes, provide a graphical display of compression rate, compression depth, and breath chest rise data for each student in the practice and certification modes, allow provision of feedback to each student in the practice and certification modes, and allow issuance of a CPR certification to each student in the certification mode.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### CPR Training and Certification Platform

In some embodiments, the platforms, systems, devices, applications, and methods described herein include a CPR training and certification platform, or use of the same. The CPR training and certification platform includes software and hardware to control the certification process by managing the aspects of the CPR certification. In some embodiments, the platform manages purchasing, online training, time scheduling, and instructor reviewed certification. In further embodiments, the platform controls the process by creating an environment where all aspects of the process can be verified and reviewed remotely by an instructor whether in real-time (synchronous) or off-line (asynchronous) at a later period.

Referring to FIG. 2, in a particular embodiment, a CPR training and certification platform described herein includes student components 200 and instructor components 250 which are linked by software in communication with a database 240. In this embodiment, student components include a module configured to deliver educational content to the student 230 and modules configured to receive input from the student in the form of video input 210 and controller input 220. In this embodiment, instructor components include a module configured to facilitate analysis of student inputs 260.

In some embodiments, a CPR training and certification platform includes a server application exchanging data and providing one or more student interfaces and one or more instructor interfaces via a computer network, such that the student and the instructor may perform their respective functions in separate locations which still meeting or exceeding published certification standards. In some embodiments, the platform is internet based. In some embodiments, the platform is cloud computing based. In further embodiments, the components of the platform communicate via the World Wide Web.

In some embodiments, the platform is intranet based. In other embodiments, the platform is near field communication (NFC) based. In other embodiments, the platform is far field communication based. In some embodiments, the platform utilizes short-wavelength wireless radio technology such as Bluetooth.

Referring to FIG. 3, in a particular embodiment, one or more centralized servers provide a student interface allowing each student to create a video skills session. In this embodiment, the one or more centralized servers also provide an instructor interface allowing each instructor to watch a real-time or recorded video skills session. In this exemplary embodiment, the platform is web-based.

Many platform configurations are suitable. The CPR training and certification platforms described herein are configurable to conduct one-on-one skills practice, review, and/or testing involving one student and one instructor, wherein the instructor views and provides individualized feedback to the student. The platforms described herein are also configurable to conduct classes wherein a plurality of students, for example, practice, review, and are tested on CPR psychomotor skills by one or more instructors.

Many class sizes are suitable. In various embodiments, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 34, 35, 36, 37, 38, 39, 40, 41, 42, 43, 44, 45, 46, 47, 48, 49, 50 or more students participate in a class. In various further embodiments, about 10, 20, 30, 40, 50, 60, 70, 80, 90, 100, 150, 200, 250, 300, 350, 400, 450, 500 or more students, including increments therein, participate in a class. Many numbers of instructors are suitable for each class. In various embodiments, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 34, 35, 36, 37, 38, 39, 40, 41, 42, 43, 44, 45, 46, 47, 48, 49, 50 or more instructors teach a class by, for example, viewing student video, reviewing student data, providing student feedback, or providing instructional materials.

In some embodiments, the CPR training and certification platforms described herein provide real-time (e.g., synchronous or substantially synchronous) interaction between students and instructors. In further embodiments, an instructor watches real-time, streaming video of a student performing psychomotor skills and provides feedback to a student or a group or class of students via a synchronous medium such as instant messaging or real-time audio or video. In other embodiments, the CPR training and certification platforms described herein provide asynchronous interaction between students and instructors. In further embodiments, an instructor watches pre-recorded video of a student performing psychomotor skills and provides feedback to a student or a group or class of students via an asynchronous medium such as email, a blog, or recorded audio or video.

### Controller Device

In some embodiments, the platforms, systems, devices, applications, and methods described herein include a controller device, or use of the same. In further embodiments, a CPR student interacts with a controller device when performing the psychomotor skills of CPR. By way of example, in some embodiments, a CPR student interacts with a controller device when performing chest compressions. By way of further example, in some embodiments, a CPR student interacts with a controller device when performing rescue breathing.

In some embodiments, a student interacts with a controller device when practicing the psychomotor skills of CPR. In some embodiments, a student interacts with a controller device when reviewing the psychomotor skills of CPR. In some embodiments, a student interacts with a controller device when being tested on the psychomotor skills of CPR. In further embodiments, a student interacts with a controller device during CPR certification.

Many controller configurations are suitable. In some embodiments, a student interacts with a controller device in isolation. For example, a student performs psychomotor skills on a controller device that is resting on the floor, on a mat, or on a gurney. In other embodiments, a student interacts with a controller device that is resting on a CPR manikin. In yet other embodiments, a student interacts with a controller device that is integrated into a CPR manikin.

In some embodiments, a controller device described herein collects student compression data. In further embodiments, compression data includes compression rate. In further embodiments, compression data includes compression depth. In still further embodiments, compression data includes both compression rate and compression depth. In some embodiments, compression data includes rebound (e.g., student allows full rebound between compressions). In some embodiments, compression data includes the number of compressions in a particular time interval. In some embodiments, compression data includes a compression:breath ratio.

In some embodiments, the controller device includes an accelerometer to collect student compression data. In further embodiments, compressions performed by a student displace the controller device in space and an accelerometer measures the displacement. In various embodiments, a student performs compressions, for example, on a CPR manikin, on a CPR manikin with an integrated controller device, and directly on a controller device. In still further embodiments, an accelerometer measures the force of compressions performed by a student. In some embodiments, the controller device further includes a gyroscope to collect data pertaining to compressions performed by a student.

In some embodiments, a controller device described herein collects student breath data. In further embodiments, breath data includes breath rate. In further embodiments, breath data includes chest rise. In still further embodiments, breath data includes both breath rate and chest rise. In some embodiments, breath data includes breath volume. In some embodiments, breath data includes number of breaths in a particular time interval. In some embodiments, breath data includes a breath:compression ratio.

In some embodiments, the controller device includes an accelerometer to collect student breath data. In further embodiments, breaths performed by a student displace the controller device in space and an accelerometer measures the displacement. In various embodiments, a student performs breaths, for example, on a CPR manikin, on a CPR manikin with an integrated controller device, and directly on a controller device. In still further embodiments, an accelerometer measures the force of breaths performed by a student. In some embodiments, the controller device further includes a gyroscope to collect data pertaining to breaths performed by a student.

In some embodiments, a controller device described herein includes a first mode. In further embodiments, in a first mode the controller device measures and collects compression data. In further embodiments, in a first mode the instrumentation of the controller device is configured to measure and collect compression data. In some embodiments, a controller device described herein includes a second mode. In further embodiments, in a first mode the controller device measures and collects breath data. In further embodiments, in a second mode the instrumentation of the controller device is configured to measure and collect breath data.

In some embodiments, a controller device described herein switches between first and second modes. In further embodiments, a controller device described herein switches between modes to alternatively measure and collect different types of student data. Many triggers are suitable for switching the modes of the controller device. In various embodiments, a controller device described herein switches modes, for example, after a particular number of compressions, after a particular number of breaths, after a particular time interval, after a pause in student activity, and the like.

In a particular embodiment, the controller device switches modes in response to the position of a microswitch integrated into the controller device. In further embodiments, the microswitch is in a first position when a CPR student places their hands on the controller device to perform chest compressions. In further embodiments, the microswitch is in a second position when a CPR student removes their hands from the controller device to perform rescue breathing. In another particular embodiment, the controller device switches modes automatically.

In some embodiments, a controller device described herein includes one or more elements for providing feedback to a student. In some embodiments, the controller device provides aural feedback by, for example, generating an audible tone, chime, buzzer, or the like. Accordingly, in some embodiments, the controller device includes a speaker. In some embodiments, the controller device provides visual feedback by, for example, generating a light, a glow, a color, or the like. Accordingly, in some embodiments, the controller device includes one or more lights, LEDs, or displays. In some embodiments, the controller device provides tactile feedback by, for example, generating a vibration or the like. In some embodiments, feedback is provided to indicate that a student is performing psychomotor skills correctly. In some embodiments, feedback is provided to indicate that a student is performing psychomotor skills incorrectly. In some embodiments, an instructor triggers the feedback provided by the controller device. In other embodiments, the controller device provides the feedback autonomously.

In some embodiments, a controller device described herein includes a communications element for the transmission of student data. In some embodiments, the communications element transmits student data to a personal computer (e.g., desktop, laptop, and the like). In further embodiments, a personal computer then transmits the student data to a server application described further herein. Many wired and wireless means are suitable for establishing communications with a personal computer including, by way of non-limiting examples, USB connector, FireWire connector, thunderbolt connector, Wi-Fi, Bluetooth, and the like. In some embodiments, the communications element transmits student data to a mobile device (e.g., smartphone, tablet computer, and the like). In further embodiments, a mobile device then transmits the student data to a server application described further herein. Many wired and wireless means are suitable for establishing communications with a mobile device including, by way of non-limiting examples, USB connector, FireWire connector, thunderbolt connector, Wi-Fi, Bluetooth, and the like. In other embodiments, the communications element transmits student data directly to a server application described further herein.

Referring to FIG. 1, in a particular embodiment, a controller device is configured to be placed on the chest of a CPR manikin. In this embodiment, the device includes an internal accelerometer and is encased in a durable and partially transparent plastic. Further in this embodiment, the device includes a USB connector to connect the device to a personal computer.

### Server Application

In some embodiments, the platforms, systems, devices, applications, and methods described herein include a server application, or use of the same. In further embodiments, the server application described herein provides user interfaces including, for example, student interfaces and instructor interfaces. In some embodiments, the server application described herein includes a plurality of modes in which to carry out distinct functions.

In some embodiments, the server application described herein includes a training mode. In further embodiments, a training mode is for scheduling and delivering learning content to one or more students. In a training mode, a student interface, for example, provides CPR lessons and courses as well as scheduling features. In further embodiments, CPR lessons and courses include, by way of non-limiting examples, text, e-books, images, audio files, video files, interactive elements, games, simulations, quizzes, and tests. In a training mode, an instructor interface, for example, provides features for monitoring and tracking student progress and performance in the CPR lessons and courses.

In some embodiments, the server application described herein includes a practice mode. In further embodiments, a practice mode is for providing one or more students with the opportunity to practice psychomotor skills. In a practice mode, an instructor interface, for example, provides real-time or recorded video input of a student performing psychomotor skills and a means to provide synchronous or asynchronous feedback to the student. In a practice mode, a student interface, for example, provides synchronous or asynchronous feedback from an instructor on a student's performance of the psychomotor skills.

In some embodiments, the server application described herein includes a certification mode. In further embodiments, a certification mode is for providing one or more students with the opportunity to be tested in the performance of psychomotor skills. In a certification mode, an instructor interface, for example, provides real-time or recorded video input of a student performing psychomotor skills and a means to provide synchronous or asynchronous feedback to the student. In some embodiments, in a certification mode, an instructor interface, presents a graphical and/or numeric display of student compression and/or breath data. In a certification mode, a student interface, for example, provides synchronous or asynchronous feedback from an instructor on a student's performance of the psychomotor skills. In some embodiments, in a certification mode, a student interface, presents a pass/fail indication to a student.

### Instructor Interface

In some embodiments, the platforms, systems, devices, applications, and methods described herein include an instructor interface, or use of the same. In further embodiments, an instructor interface described herein facilitates the remote evaluation of CPR students with regard to coursework and performance of psychomotor skills. In still further embodiments, an instructor interface described herein facilitates the issuance of a CPR certification to a student when all certification requirements are met. In some embodiments, the instructor interface is implemented as a web application. In other embodiments, the instructor interface is implemented as a mobile application (e.g., an iPad app) or a standalone application (e.g., a desktop executable).

Referring to FIG. 5, in a particular embodiment, an instructor interface includes management tools. In this embodiment, the management tools include a remote skills verification lobby. Further, in this embodiment, the remote skills verification lobby displays information for a particular class of students. A title, class number, training date, list of students, and remote skills verification time slot for each student are displayed.

Referring to FIG. 6, in a particular embodiment, an instructor interface includes management tools. In this embodiment, the management tools include an open hour listing tool. Further, in this embodiment, the open hour listing tool displays a calendar view. For each day, the calendar presents existing time slots scheduled for remote skills verification sessions for students. The features also include elements for creating a new time slot.

Referring to FIG. 7, in a particular embodiment, an instructor interface includes management tools. In this embodiment, the management tools include class management and progress tracking tools. Further, in this embodiment, the interface is tabbed and provides optional access to class details, a class roster, and class notifications. In this embodiment, the progress tracking tools include elements to configure score, pass/fail status, and notes for each student. Progress tracking also includes numeric class data for number of students, assigned students, students in progress, and students completed.

Referring to FIG. 8, in a particular embodiment, an instructor interface includes tools for remote skills monitoring. In this embodiment, the tools for remote skills monitoring include a video player for watching student performance and a chat interface for providing feedback to the student. Further, in this embodiment, the tools for remote skills monitoring include a list of completed skills and list of skills to be completed. The tools for remote skills monitoring also include a display of student compression data indicating number of compressions, rate of compressions, and depth of compressions. In this embodiment, the student data is displayed in a graphical chart format as well as numeric data for last compression depth, last compression rate, average compression depth, and average compression rate.

### Student Interface

In some embodiments, the platforms, systems, devices, applications, and methods described herein include a student interface, or use of the same. In further embodiments, a student interface described herein facilitates the scheduling and completion of CPR coursework and practice and review of psychomotor skills. In still further embodiments, a student interface described herein facilitates scheduling and performance of remote psychomotor skills evaluation by a CPR instructor. In still further embodiments, a student interface described herein facilitates the receipt of a CPR certification when all certification requirements are met. In some embodiments, the student interface is implemented as a web application. In other embodiments, the student interface is implemented as a mobile application (e.g., an iPad app) or a standalone application (e.g., a desktop executable).

Referring to FIG. 9, in a particular embodiment, a student interface includes a home or welcome screen that provides access to functions such as registration and training course purchase, training course participation, skills evaluation session scheduling, psychomotor skills practice, and CPR certification.

Referring to FIG. 10, in a particular embodiment, a student interface includes student account registration and log-in elements.

Referring to FIG. 11, in a particular embodiment, a student interface includes a listing of courses in which a student is enrolled.

Referring to FIG. 12, in a particular embodiment, a student interface includes tools for participation in a CPR training course. In this embodiment, the course is an MEDIC First Aid certification course and the interface includes an interactive table of contents providing access to a plurality of individual lessons.

Referring to FIG. 13, in a particular embodiment, a student interface includes tools for a student to schedule a mutually accommodating time slot to complete remote skills verification with a CPR instructor. In this embodiment, the scheduling tools include a calendar view presenting time slots for each day.

Referring to FIG. 14, in a particular embodiment, a student interface includes graphical feedback on student psychomotor skills performance. In this embodiment, the feedback is in the form of a display of student compression data indicating number of compressions, rate of compressions, and depth of compressions. Further, in this embodiment, the student data is displayed in a graphical chart format as well as numeric data for last compression depth, last compression rate, average compression depth, and average compression rate.

Referring to FIG. 15, in a particular embodiment, a student interface includes tools for performance of remote skills verification. In this embodiment, the tools for performance of remote skills verification include a video player for providing video input to a CPR instructor and a chat interface for receiving feedback from the instructor. Further, in this embodiment, the tools for performance of remote skills verification include a list of completed skills.

### Certification

In some embodiments, the platforms, systems, devices, applications, and methods described herein include a process for CPR certification, or use of the same. In further embodiments, the process described herein meets or exceeds standards for CPR certification established by nationally recognized organizations, including the Health and Safety Institute, American Heart Association, and the American Red Cross.

Referring to FIG. 4, in a particular embodiment, the CPR certification process starts with a student creating a learning session for the CPR course needed for certification. In this embodiment, the student purchases a blended online course that includes skills video 400 and subsequently participates in and completes the course 410 by watching the on-line cognitive portion and completing the quiz and testing portions. The student then watches videos and practices, psychomotor skills 420 in preparation to the skill evaluation. In this embodiment, the student finds an open time with an instructor to have a real-time online skills evaluation or follows the off-line skills process for submission to an instructor 430. In this embodiment, students record a skills performance video with or without the use of a controller device to collect compression and breath data 440. After the skills evaluation, the student can review data with the instructor 450 and gain remediation if they do not meet the skills requirement 470. Once the instructor is satisfied the student meets the requirements for certification the session is closed and a certification card is issued 460.

### Games

In some embodiments, the platforms, systems, devices, applications, and methods described herein include a student interface providing feedback on CPR psychomotor skills in the form of a software game application. In further embodiments, student compression and/or breath data is collected by a controller device and pushed to a variety of external game applications to demonstrate the correctness of CPR performance by the student. Providing feedback in the form of a game remedies deficiencies of current CPR training and certification technologies by encouraging improved student attention, motivation, and competition.

In some embodiments, one or more games provide feedback in a practice mode described herein. In other embodiments, one or more games provide feedback in a certification mode described herein. In yet other embodiments, one or more games provide feedback in both practice and certification modes described herein.

Many types of game applications are suitable for use with the interface for providing feedback on student CPR psychomotor skills. By way of example, in various embodiment, suitable games include word games, sports games, adventure games, interactive charts and graphs, and the like wherein student CPR skills affect the events and outcome of the game. In further embodiments, student CPR psychomotor skills including, for example, chest compression rate, chest compression depth, breathing rate, breathing chest rise, breath volume, ratio of compressions to breaths, and the like affect the events and outcome of the game. In some embodiments, good CPR practices, which conform to certification standards affect the game in a positive way and facilitate a good game outcome, such as a high score. In some embodiments, poor CPR practices, which do not conform to certification standards affect the game in a negative way and facilitate a bad game outcome, such as a low score.

By way of further example, in a particular embodiment, suitable games include driving games. Referring to FIG. 16, in a particular embodiment, student CPR skills affect a car on a race track. In this embodiment, good student CPR practices, which conform to certification standards, keep the car on the track and poor student CPR practices, which do not conform to certification standards, will cause the car to veer off the track and potentially crash. Further in this embodiment, points are accumulated for the amount of time the car stays on the track and a student's score reflects how long they were able to keep the car driving on the race track.

By way of further example, in a particular embodiment, suitable games include an interactive representation of a patient. Referring to FIG. 17, in a particular embodiment, student CPR skills affect the health of a representation of a patient. In this embodiment, good student CPR practices, which conform to certification standards, improve the virtual patient's health and poor student CPR practices, which do not conform to certification standards, will cause the virtual patient's health to deteriorate. In this embodiment, graphic elements representing compressions and breaths move from right to left across the top of the interface. As each graphic icon passes by a vertical line, the student must correctly perform the indicated CPR skill. Thus, this game encourages correct skill performance as well as timing. Further in this embodiment, points are accumulated for improving the patient's health and a student's score reflects the degree of improvement they achieved.

In some embodiments, a game is selected from a library of games by a CPR student. In other embodiments, a game is selected from a library of games by a CPR instructor. In some embodiments, the game play is captured in the form of audio and video media allowing game replay. In further embodiments, each time a user completes a game, the entire game is optionally replayed exactly as the interaction occurred.

In some embodiments, student game data (e.g., scores, performance, video, etc.) can be pushed to a custom website by a student or an instructor. In further embodiments, this process automatically creates training records in the online training platform. Referring to FIG. 18, in a particular embodiment, a web site hosts a high score board for a game used for providing student feedback for CPR training In this embodiment, student scores are presented in descending order to encourage attention, performance, and competition.

### Hub Device

As described herein, in some embodiments, a student interacts with a controller device when performing the psychomotor skills of CPR. In further embodiments, a controller device includes elements, such as an accelerometer, to generate data reflecting the student's performance of the psychomotor skills of CPR including, by way of non-limiting examples, chest compression rate, chest compression depth, breath rate, breath volume, breath chest rise, ratio of compressions to breaths, number of compressions, number of breaths, and the like.

In some embodiments, the platforms, systems, devices, applications, and methods described herein include a hub device. In further embodiments, a hub device receives data from a plurality of controller devices. In various embodiments, a hub device receives data from about 2, 3, 4, 5, 6, 7, 8, 9, 10, 11, 12, 13, 14, 15, 16, 17, 18, 19, 20, 21, 22, 23, 24, 25, 26, 27, 28, 29, 30 or more controller devices. In a particular embodiment, a hub device receives data from the controller devices used by a class of CPR students. In some embodiments, a hub device receives data wirelessly from a plurality of controller devices. Many wireless communications protocols are suitable for receipt of the data. In various embodiments, suitable wireless communications protocols include, by way of non-limiting examples, infrared, RFID, Bluetooth, ZigBee, 802.11x (e.g., Wi-Fi), WiMAX, cellular protocols (e.g., 3G/4G/LTE, etc.), and combinations thereof. In other embodiments, a hub device receives data wirelessly from a plurality of controller devices by wired connection. Many wired connections are suitable including, for example, Universal Serial Bus (USB) (type A and B, standard, mini, and micro varieties), FireWire, Thunderbolt, etc.).

In some embodiments, a hub device processes the received data and transmits the processed data to one or more computing devices such as servers, desktop computers, laptop computers, mobile computing devices, and the like. In further embodiments, a hub device transmits processed data wirelessly to one or more computing devices. Many wireless communications protocols are suitable for transmission of the data. In various embodiments, suitable wireless communications protocols include, by way of non-limiting examples, infrared, RFID, Bluetooth, ZigBee, 802.11x (e.g., Wi-Fi), WiMAX, cellular protocols (e.g., 3G/4G/LTE, etc.), and combinations thereof. In other embodiments, a hub device transmits processed data by wired connection to one or more computing devices. Many wired connections are suitable including, for example, Universal Serial Bus (USB) (type A and B, standard, mini, and micro varieties), FireWire, Thunderbolt, etc.).

In some embodiments, the hub device comprises one or more processors to process (e.g., collect and compile) raw controller data which is transmitted to the one or more computing devices. In some embodiments, the hub device comprises firmware to control the data processing. In some embodiments, the hub device comprises a power source to power board systems. In some embodiments, the hub device comprises a wireless communications element to wirelessly distribute processed data. In some embodiments, the hub device comprises or more wired connector ports to connect the plurality of controller devices and accept the raw data.

Referring to FIG. 19, in a particular embodiment, a hub device is a 4x hub device 1900 comprising four USB connector ports to receive data from up to four controller devices 1910 simultaneously. In this embodiment, the hub includes a USB hub 1920 which receives raw linear acceleration and rotation rate data from the connected controller devices and provides the data to a high end uC digital signal processor (DSP) x4 1930. Further in this embodiment, the DSP processes the signal and provides breath and compression data to a Bluetooth module 1940 via a universal asynchronous receiver/transmitter (UART). The Bluetooth module in turn wirelessly transmits the processed data to one or more mobile devices 1950 providing a graphic user interface. In this embodiment, the DSP also provides breath and compression data to a host personal computer 1960 connected to the hub via a USB connection.

Referring to FIG. 20, in a particular embodiment, a hub device is a 6x hub including a CPU board 2000, which receives input from up to six controller devices via USB connectors 2010. In this embodiment, the hub device includes both Bluetooth and USB output options 2020 for transmitting collected data to a computing device. Further in this embodiment, the hub device includes six batteries 2030 (optionally rechargeable) to power the hub device.

The platforms and systems for CPR training and certification described herein, in some embodiments, comprise a hub device also described herein. In this configuration, the platforms and systems for CPR training and certification overcome additional shortcomings of the current technologies. The hub devices described herein advantageously facilitate training and certification of a plurality of CPR students simultaneously. Moreover, the hub devices described herein advantageously facilitate a practice mode that includes multiplayer games, which encourage attention, motivation, performance, and competition.

For example, in some embodiments, a hub device is configured to receive data from several controller devices, process the data, and wirelessly broadcast the data to mobile device, personal computer, and/or other devices that run gaming software. In further embodiments, each student views their own game interface to receive feedback on their performance. In still further embodiments, all the students are grouped together and displayed on one screen for review by an instructor or displayed for class viewing. In such embodiments, a CPR instructor quickly identifies low performing students and can offer further instruction or assistance.

Referring to FIG. 21, in a particular embodiment, four or six controller devices 2100 are connected to a hub device 2120. In this embodiment, each CPR student performs CPR psychomotor skills in a practice mode by playing a game, which responds to measured parameters which characterize the quality of the student's psychomotor skills (e.g., conformity to CPR skill standards, etc.). Further in this embodiment, the student data is grouped for viewing by an instructor on an instructor computer 2130.

In some embodiments, CPR students compete with themselves by trying to improve their personal best scores in a game described herein. In other embodiments, CPR students compete with each other by trying to beat the best scores of the other students. In some embodiments, each set of student data is optionally saved and stored and each game is optionally saved and stored as well.

### Digital Processing Device

In some embodiments, the platforms, systems, devices, applications, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the digital processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a digital camera. In some embodiments, a digital camera captures digital images. In some embodiments, the digital camera is an autofocus camera. In some embodiments, a digital camera is a charge-coupled device (CCD) camera. In further embodiments, a digital camera is a CCD video camera. In other embodiments, a digital camera is a complementary metal-oxide-semiconductor (CMOS) camera. In some embodiments, a digital camera captures still images. In other embodiments, a digital camera captures video images. In various embodiments, suitable digital cameras include 1, 2, 3, 4, 5, 6, 7, 8, 9, 10, 11, 12, 13, 14, 15, 16, 17, 18, 19, 20, and higher megapixel cameras, including increments therein. In some embodiments, a digital camera captures color digital images. In other embodiments, a digital camera captures grayscale digital images. In various embodiments, digital images are stored in any suitable digital image format. Suitable digital image formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP. In various embodiments, digital images are stored in any suitable digital video format. Suitable digital video formats include, by way of non-limiting examples, AVI, MPEG, Apple® QuickTime®, MP4, AVCHD®, Windows Media®, DivX™, Flash Video, Ogg Theora, WebM, and RealMedia.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the platforms, systems, devices, applications, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, devices, applications, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, devices, applications, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, devices, applications, and methods disclosed herein include one or more databases, or use of the same. In view of the disclosure provided herein, those of skill in the art will recognize that many databases are suitable for storage and retrieval of student information, instructor information, and/or certification information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A web-based CPR training and certification platform comprising:
a. a controller device comprising:
i. a first mode for collecting student compression data;
ii. a second mode for collecting student breath data;
iii. a software module for providing feedback on the compression and breath data;
iv. a software module for transmitting the data to a server application;
b. a server processor configured to provide an application comprising:
i. a training mode, a practice mode, and a certification mode;
ii. a software module for providing a student interface, the student interface configured to deliver learning content in the training mode and display instructor feedback in the practice mode;
iii. a software module for providing an instructor interface, the instructor interface configured to provide video of student psychomotor skills in the practice and certification modes, provide a graphical display of student compression and breath data in the practice and certification modes, allow provision of feedback in the practice and certification modes, and allow issuance of a CPR certification in the certification mode.

2. The platform of claim 1, wherein the controller device automatically switches between the first mode and the second mode.

3. The platform of claim 1, wherein the student compression data comprises compression rate and compression depth.

4. The platform of claim 1, wherein the student breath data comprises chest rise.

5. The platform of claim 1, wherein the controller device comprises an accelerometer, a gyroscope, or both.

6. The platform of claim 1, wherein the controller device comprises a CPR manikin.

7. The platform of claim 1, wherein the controller device is in communication with a computer.

8. The platform of claim 7, wherein the transmission of data to a server processor is performed via the computer.

9. The platform of claim 1, wherein the learning content comprises an online instructional program to verify cognitive CPR knowledge.

10. The platform of claim 1, wherein the video of student psychomotor skills is substantially real-time video.

11. The platform of claim 1, wherein the feedback provided by the instructor comprises text, images, audio, video, or a combination thereof.

12. The platform of claim 1, wherein the graphical display of student compression and breath data comprises a compression:breath ratio.

13. The platform of claim 1, wherein, in the practice mode, the compression and breath data are generated by a student playing a game, the game requiring performance of CPR psychomotor skills and the feedback on the compression and breath data is provided by reactions of the game.

14. A CPR training and certification device comprising:
a. an accelerometer, a gyroscope, or both;
b. a first mode for collecting student compression data by the accelerometer;
c. a second mode for collecting student breath data by the accelerometer, wherein the device automatically switches between the first mode and the second mode;
d. a software module for providing feedback on the compression and breath data; and
e. a software module for transmitting the data to a server application for evaluation by a CPR instructor.

15. The device of claim 14, wherein the student compression data comprises compression rate and compression depth and the student breath data comprises chest rise.

16. The device of claim 14, integrated with a CPR manikin.

17. The device of claim 14, wherein the device is in communication with a computer.

18. The device of claim 17, wherein the communication is performed by Wi-Fi, Zigbee, Bluetooth, or a combination thereof.

19. The device of claim 17, wherein the transmission of data to a server processor is performed via the computer.

20. The device of claim 14, wherein the feedback is provided during training and suppressed during certification.

21. The device of claim 14, comprising a mobile processing device, wherein the first mode, the second mode, and the software modules are implemented as a mobile application.

22. A non-transitory computer-readable storage media encoded with a computer program including instructions executable by a processor to create a CPR certification application, the application adapted for a CPR instructor, the application comprising:
a. a software module configured to provide video of the student performing psychomotor skills;
b. a software module configured to receive student compression and breath data;
c. a software module configured to provide a graphical display of student compression and breath data;
d. a software module configured to allow provision of feedback; and
e. a software module configured to allow issuance of a CPR certification.

23. The media of claim 22, wherein the student compression data comprises compression rate and compression depth and the student breath data comprises chest rise.

24. The media of claim 22, wherein the video of student psychomotor skills is substantially real-time video.

25. The media of claim 22, wherein the video of student psychomotor skills is archived video.

26. The media of claim 22, wherein the feedback provided by the instructor comprises text, images, audio, video, or a combination thereof.

27. The media of claim 22, wherein the graphical display of student compression and breath data comprises a compression:breath ratio.

28. The media of claim 22, wherein, the compression and breath data are generated by a student playing a game, the game requiring performance of CPR psychomotor skills.

29. A web-based CPR training and certification platform comprising:
a. a plurality of controller devices, each controller device operated by a student, each controller device comprising:
i. an accelerometer;
ii. a first mode for collecting raw student compression data via the accelerometer;
iii. a second mode for collecting raw student breath data via the accelerometer;
iv. a means for transmitting the raw compression and breath data to a hub device;
b. a hub device comprising:
i. a means for receiving raw compression and breath data from each of the controller devices;
ii. a digital signal processor configured to process the raw compression and breath data and generate compression rate, compression depth, and breath chest rise data for each of the controller devices;
iii. a means for transmitting the compression rate, compression depth, and breath chest rise data to a server application;
c. a server processor configured to provide an application comprising:
i. a training mode, a practice mode, and a certification mode;
ii. a software module for providing a student interface, the student interface configured to deliver learning content to each student in the training mode and display instructor feedback to each student in the practice mode;
iii. a software module for providing an instructor interface, the instructor interface configured to provide video of student psychomotor skills for each student in the practice and certification modes, provide a graphical display of compression rate, compression depth, and breath chest rise data for each student in the practice and certification modes, allow provision of feedback to each student in the practice and certification modes, and allow issuance of a CPR certification to each student in the certification mode.

30. The platform of claim 29, wherein the plurality of controller devices comprises about 2 to about 8 controller devices.
